(19) United States
(12) Patent Application Publication
(10) Pub. No.: US 2026/0175692 A1
(43) Pub. Date: Jun. 25, 2026

(54) POWER TRANSMISSION SYSTEM FOR ELECTRICALLY POWERED VEHICLE

(71) Applicant: SUBARU CORPORATION, Tokyo (JP)

(72) Inventor: Yoshitaka ARAI, Tokyo (JP)

(21) Appl. No.: 18/727,150

(22) PCT Filed: Mar. 23, 2023
(86) PCT No.: PCT/JP2023/011505

§ 371 Date: Jul. 8, 2024

(51) Int. Cl. B60L 3/00; B60L 3/04; B60L 53/12; B60L 58/13

(52) U.S. Cl. CPC B60L 3/0046; B60L 3/04; B60L 53/12; B60L 58/13

(57) ABSTRACT

A power transmission system for an electrically powered vehicle including a battery that stores power for traveling and an electric device that receives the power from the battery includes a power intake unit that can take in power from a charging facility, a charger that charges the battery using the power, first and second power lines that transmit the power respectively between the electric device and the battery and between the battery and the charger, a relay that can cut off the first power line without cutting off the second power line, and a controller that controls the relay.

The controller disconnects the relay after performing current generation processing when a request for disconnecting the relay is issued based on an abnormality. The current generation processing causes a current flowing in a direction in which a current of the relay decreases to flow between the charger and the battery.

### TECHNICAL FIELD

The present invention relates to a power transmission system for an electrically powered vehicle.

### BACKGROUND

An electrically powered vehicle includes a system main relay that can isolate a high voltage battery from a system power line. Patent Document 1 describes that a system main relay is disconnected in a state in which no current is flowing through the system main relay, in order to suppress an occurrence of welding or the like at a contact of the relay.

CITATION LIST

### Patent Literature

Patent Document 1: JP 2012-223053 A

### SUMMARY

### Technical Problem

A current that is exchanged between a high-voltage battery and an electric device flows through a system main relay. It takes some time to reduce the current of the system main relay by controlling the electric device. In addition, a situation may arise in which it is difficult to reduce the current by controlling the electric device. Therefore, when a request for quickly disconnecting the system main relay is issued, it is not easy to reduce the current of the system main relay and then respond to the request for quick disconnection.

An object of the present invention is to provide a power transmission system for an electrically powered vehicle that can respond to a request for quickly disconnecting a relay while suppressing a progress of deterioration of the relay.

### Solution to Problem

An aspect of the present invention provides a power transmission system for an electrically powered vehicle. The power transmission system is configured to be mounted on the electrically powered vehicle. The electrically powered vehicle includes a battery configured to store power for traveling and an electric device configured to receive the power from the battery. The power transmission system includes: a power intake unit that configured to take in power from a charging facility provided outside the electrically powered vehicle; a charger configured to charge the battery using the power taken in via the power intake unit; a first power line that configured to transmit the power between the electric device and the battery; a second power line configured to transmit the power between the battery and the charger; a relay configured to cut off the first power line without cutting off the second power line; and a controller configured to control the relay. The controller is configured to disconnects the relay after performing current generation processing when a request for disconnecting the relay is issued based on an abnormality. The current generation processing causes a current flowing in a direction in which a current of the relay decreases to flow between the charger and the battery.

### Advantageous Effects of Invention

According to the present invention, it is possible to respond to a request for quickly disconnecting a relay while suppressing a progress of deterioration of the relay.

### BRIEF DESCRIPTION OF DRAWINGS

FIG. 1 is a block diagram illustrating an electrically powered vehicle and a power transmission system according to an embodiment of the present invention.

FIG. 2A is a diagram illustrating a first stage of relay disconnection processing based on an abnormality during discharging of a battery.

FIG. 2B is a diagram illustrating a second stage of relay disconnection processing based on an abnormality during discharging of a battery.

FIG. 2C is a diagram illustrating a third stage of relay disconnection processing based on an abnormality during discharging of a battery.

FIG. 2D is a diagram illustrating a fourth stage of relay disconnection processing based on an abnormality during discharging of a battery.

FIG. 3A is a diagram illustrating a first stage of relay disconnection processing based on an abnormality during charging of a battery.

FIG. 3B is a diagram illustrating a second stage of relay disconnection processing based on an abnormality during charging of a battery.

FIG. 3C is a diagram illustrating a third stage of relay disconnection processing based on an abnormality during charging of a battery.

FIG. 3D is a diagram illustrating a fourth stage of relay disconnection processing based on an abnormality during charging of a battery.

FIG. 4 is a flowchart illustrating an example of relay disconnection processing based on an abnormality, performed by a controller.

### DESCRIPTION OF EMBODIMENTS

An embodiment of the present invention will be described in detail below with reference to the drawings. In the present specification, opening of a contact of a relay is referred to as “disconnection” of the relay, and closing of the contact of the relay is referred to as “connection” of the relay. In addition, of a current of a battery 12, a current flowing in a direction in which power is discharged from the battery 12 is referred to as a “discharge current”, and a current flowing in a direction in which power is transmitted to the battery 12 is referred to as a “charge current”.

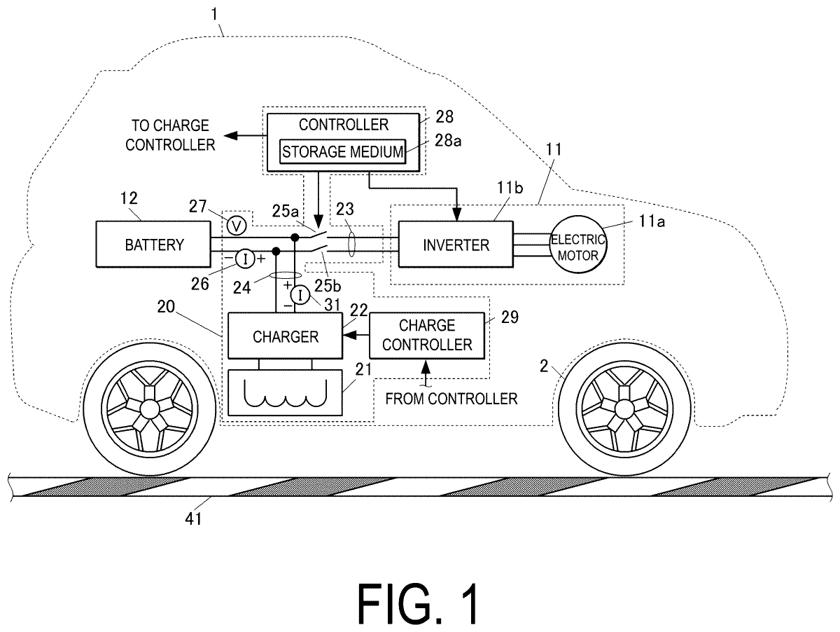

FIG. 1 is a block diagram illustrating an electrically powered vehicle and a power transmission system according to an embodiment of the present invention. An electrically powered vehicle 1 illustrated in FIG. 1 includes driving wheels 2, the battery 12 that stores power for traveling, and an electric device 11 that is driven by the power of the battery 12. The electric device 11 includes an electric motor 11a that generates power for the driving wheels 2, and an inverter 11b that converts the power between the battery 12 and the electric motor 11a. The electrically powered vehicle 1 further includes a power transmission system 20.

The power transmission system 20 includes a power intake unit 21 that can take in power from a charging facility provided outside the electrically powered vehicle 1, a charger 22 that can charge the battery 12 using the power taken in via the power intake unit 21, a first power line 23 that transmits power between the electric device 11 and the battery 12, a second power line 24 that transmits power between the battery 12 and the charger 22, relays 25a, 25b that can cut off the first power line 23 without cutting off the second power line 24, a current sensor 26 that detects a current of the battery 12, a voltage sensor 27 that detects a voltage of the battery 12, a controller 28 that controls the relays 25a, 25b, a charge controller 29 that controls the charger 22, and a current sensor 31 that detects a current flowing through the charger 22.

The controller 28 is a vehicle controller that performs travel control of the electrically powered vehicle 1, and the vehicle controller also serves as the controller 28 that controls the relays 25a, 25b. Note that the controller 28 that controls the relays 25a, 25b may be configured separately from the vehicle controller, and the controller 28 and the vehicle controller may be configured so as to cooperate with each other by communicating with each other.

In addition to the electric motor 11a and the inverter 11b, the electric device 11 may include other devices such as a heater, an air-conditioning device, a DC/DC converter, and an in-vehicle inverter.

The battery 12 is, for example, a lithium-ion secondary battery, a nickel-hydrogen secondary battery, or the like, and outputs a high voltage equal to or higher than 80 V (for example, 100 V system, 200 V system, or the like).

The current sensor 26 is provided on a power line coupled to a negative electrode of the battery 12 and detects a value of the current flowing through the negative electrode of the battery 12. The current sensor 26 may be a magnetic current sensor with a core, a coreless magnetic current sensor, or a resistance-type current sensor. The resistance-type refers to a type in which a current is caused to flow through a resistor such as a shunt resistor, and the current is detected from a voltage between both ends of the resistor. Note that the current sensor 26 may be provided on a power line coupled to a positive electrode of the battery 12 and may detect a value of the current flowing through the positive electrode of the battery 12. In addition, the current sensor 26 may be configured to detect values of the currents at multiple locations of branching power lines and to calculate the value of the current flowing through the battery 12 from those current values.

The relays 25a, 25b are system main relays. The relays 25a, 25b are switched between a disconnected state and a connected state under control of the controller 28. The relays 25a, 25b are provided in the middle of the first power line 23, at a position closer to the electric device 11 than a position at which the first power line 23 and the second power line 24 are coupled to each other. Thus, when the relays 25a, 25b are disconnected, the first power line 23 can be cut off without cutting off the second power line 24.

The power intake unit 21 is configured to be able to take in power during traveling, from an external charging facility 41 provided in a traveling lane and also to be able to transmit the power to the external charging facility 41 during traveling. The power intake unit 21 is, for example, a power transmission coil and transmits power to and from the charging facility 41 through an electromagnetic action. For example, the external charging facility 41 has a configuration in which multiple coils are arranged along the traveling lane. The charging facility 41 may adopt any configuration as long as the charging facility 41 can transmit, in a non-contact manner, power to and from the electrically powered vehicle 1 that is traveling.

The charger 22 converts the power (for example, AC power) taken in from the charging facility 41 via the power intake unit 21 into power for charging (for example, DC power), and outputs the power to the second power line 24, thereby charging the battery 12. Hereinafter, this operation is referred to as a “charge operation”. Conversely, the charger 22 receives the power (for example, DC power) of the battery 12, converts the power into power for transmission (for example, AC power), and transmits the power to the power intake unit 21, thereby transmitting the power to the charging facility 41. Hereinafter, this operation is referred to as a “discharge operation”. The power transmitted to the charging facility 41 is transmitted to an electric load provided in the charging facility 41 or is transmitted to another electrically powered vehicle traveling through the same charging facility 41.

The current sensor 31 is provided at the power line coupled to the positive electrode of the charger 22 and detects the value of the current flowing through the positive electrode of the charger 22. The current sensor 31 may be located inside the charger 22 or may be located outside the charger 22. The current sensor 31 may be a magnetic current sensor with a core, a coreless magnetic current sensor, or a resistance-type current sensor. Note that the current sensor 31 may be provided at the power line coupled to the negative electrode of the charger 22 and may detect the value of the current flowing through the negative electrode of the charger 22. In addition, the current sensor 31 may be configured to detect values of the currents at multiple locations of branching power lines and to calculate the value of the current flowing through the charger 22 from those current values.

The charge controller 29 is a microcomputer that operates in accordance with a control program and controls the operations of the charger 22. The charge controller 29 controls the charger 22 so that the charger 22 performs the discharge operation and the charge operation.

The controller 28 is the microcomputer that operates in accordance with the control program. As an operation of the vehicle controller, the controller 28 controls the inverter 11b so that the electric motor 11a performs a power running operation based on an acceleration command from a driver who drives the vehicle or an automatic driving system. By this control, the discharge current flows from the battery 12 to the inverter 11b, and the battery 12 is discharged. Further, as an operation of the vehicle controller, the controller 28 controls the inverter 11b so that the electric motor 11a performs a regenerative operation based on a deceleration command from the driver or the automatic driving system. By this control, the charge current flows from the inverter 11b to the battery 12, and the battery 12 is charged.

Further, as an operation of the vehicle controller, the controller 28 monitors the state of the electric device 11 and issues a request for disconnecting the relays 25a, 25b by itself when a specific abnormality occurs.

The controller 28 controls opening and closing of each of the relays 25a, 25b. For example, the controller 28 connects the relays 25a, 25b when a system of the electrically powered vehicle 1 is activated and disconnects the relays 25a, 25b when the system of the electrically powered vehicle 1 is deactivated. Further, when the disconnection request based on the abnormality is issued, the controller 28 disconnects the relays 25a, 25b. An output of the current sensor 26, an output of the voltage sensor 27, and an output of the current sensor 31 are transmitted to the controller 28.

The controller 28 can further communicate with the charge controller 29 and can control the charger 22 via the charge controller 29.

### Examples of Abnormality

In the electrically powered vehicle 1, when a failure such as a short circuit occurs in the electric device 11, an abnormality occurs in which the discharge current continues to flow from the battery 12 to the electric device 11. In addition, when an unexpected regenerative operation is performed in the electric motor 11a due to a failure in the inverter 11b or a failure in a control system of the inverter 11b, an abnormality occurs in which an unexpected charge current continues to flow from the inverter 11b to the battery 12.

When the above-described abnormality occurs, the controller 28 issues the request for disconnecting the relays 25a, 25b based on the abnormality from the viewpoint of protecting the battery 12. Then, based on the disconnection request, the controller 28 performs processing for quickly disconnecting the relays 25a, 25b. By this processing, it is possible to suppress an abnormal discharge current from continuing to flow from the battery 12, or an abnormal charge current from continuing to flow to the battery 12.

Note that the request for disconnecting the relays 25a, 25b based on the abnormality is not limited to being issued based on the abnormal continuation of the charge current flowing to the battery 12, or the abnormal continuation of the discharge current flowing from the battery 12. The request for disconnecting the relays 25a, 25b based on the abnormality may be issued based on another abnormality such as a collision detection of the electrically powered vehicle 1. Alternatively, the request for disconnecting the relays 25a, 25b based on the abnormality may be issued based on a discharge exceeding a dischargeable power Wout of the battery 12 and based on a charge exceeding a chargeable power Win of the battery 12.

### Relay Disconnection Processing during Discharging

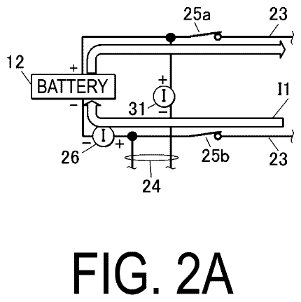

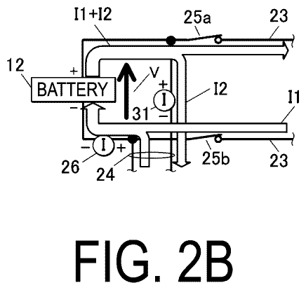

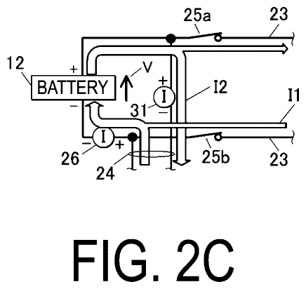

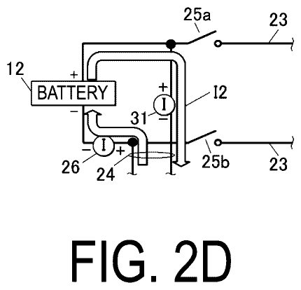

Next, a description will be given of processing performed when the request for disconnecting the relays 25a, 25b based on the abnormality is issued while power is being discharged from the battery 12 to the electric device 11 (hereinafter referred to as “during discharging”). FIGS. 2A to 2D are diagrams respectively illustrating a first stage to a fourth stage of the relay disconnection processing based on the abnormality during discharging.

Since power is being discharged at a stage prior to the issuance of the disconnection request, a discharge current I1 is flowing from the battery 12 to the electric device 11, as illustrated in FIG. 2A. As illustrated in FIG. 2B, when the disconnection request based on the abnormality is issued, first, the controller 28 performs current generation processing in which a current I2 is caused to flow between the charger 22 and the battery 12 in a direction in which the current flowing through the relays 25a, 25b decreases.

For example, as illustrated in FIG. 2C, the controller 28 requests the charge controller 29 to perform the discharge operation and transmits power from the battery 12 to the external charging facility 41 via the charger 22 and the power intake unit 21. By this operation, the discharge current I2 flows from the battery 12 to the charger 22. The generation period of the discharge current I2 may be, for example, a short period of 1 millisecond to 1000 milliseconds.

The battery 12 has a limited instantaneous discharge capacity. Therefore, due to the discharge current I2 of the current generation processing, the battery 12 is discharged so as to approach the limit of the discharge capacity, and, as illustrated in FIG. 2C, a voltage V of the battery 12 decreases. Then, due to the decrease in the voltage V, the discharge current I1 from the battery 12 to the electric device 11, that is, the discharge current I1 flowing through the relays 25a, 25b decreases. It is sufficient that the decrease in the discharge current I1 corresponds to a decrease large enough to be able to reduce the magnitude of an arc generated when disconnecting the relays 25a, 25b.

Then, as illustrated in FIG. 2D, the controller 28 disconnects the relays 25a, 25b at a timing at which the discharge current I1 flowing through the relays 25a, 25b has decreased. If the relays 25a, 25b are disconnected when a large current is flowing through the relays 25a, 25b, a large arc may be generated and contacts of the relays 25a, 25b may deteriorate. However, since the current generation processing causes the discharge current I1 flowing through the relays 25a, 25b to decrease, the deterioration of the contact of each of the relays 25a, 25b due to the disconnection is reduced.

### Relay Disconnection Processing during Charging

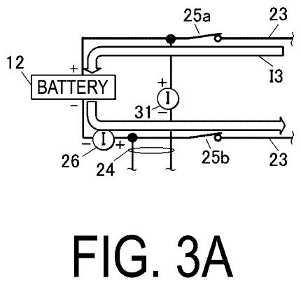

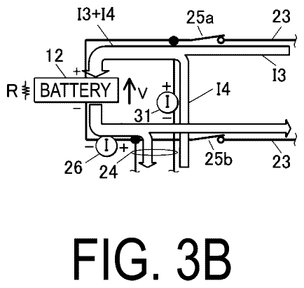

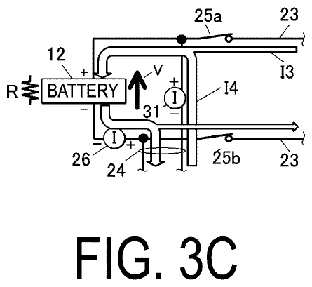

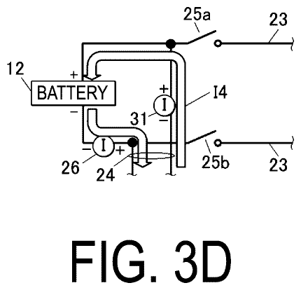

Next, a description will be given of a case where the request for disconnecting the relays 25a, 25b based on the abnormality is issued while power is being transmitted from the electric device 11 to the battery 12 (hereinafter referred to as “during charging”). Note that a time period during which the battery 12 is charged only by the power transmitted from the external charging facility 41 is excluded from the time period “during charging” described above. FIGS. 3A to 3D are diagrams respectively illustrating a first stage to a fourth stage of the relay disconnection processing based on the abnormality during charging.

Since power is being charged at a stage prior to the performance of the disconnection processing, a charge current I3 is transmitted from the electric device 11 to the battery 12, as illustrated in FIG. 3A. As illustrated in FIG. 3B, when the disconnection request based on the abnormality is issued, first, the controller 28 performs current generation processing in which a current I4 is caused to flow between the charger 22 and the battery 12 in the direction in which the current flowing through the relays 25a, 25b decreases.

For example, as illustrated in FIG. 3C, the controller 28 requests the charge controller 29 to perform the charge operation and transmits the power from the external charging facility 41 to the battery 12 via the power intake unit 21 and the charger 22. By this operation, the charge current I4 flows from the charger 22 to the battery 12. The generation period of the charge current I4 may be, for example, a short period of 1 millisecond to 1000 milliseconds.

The battery 12 has a limited instantaneous charge capacity. Therefore, due to the charge current I4 of the current generation processing, the battery 12 is charged so as to approach the limit of the charge capacity, and, as illustrated in FIG. 3C, an internal resistance R of the battery 12 increases, or the voltage V of the battery 12 rises. As a result, the charge current I3 transmitted from the electric device 11 to the battery 12, namely, the charge current I3 flowing through the relays 25a, 25b decreases. It is sufficient that the decrease in the charge current I3 corresponds to a decrease large enough to be able to reduce the magnitude of the arc generated when disconnecting the relays 25a, 25b.

Then, as illustrated in FIG. 3D, the controller 28 disconnects the relays 25a, 25b at a timing at which the current flowing through the relays 25a, 25b has decreased. If the relays 25a, 25b are disconnected when a large current is flowing through the relays 25a, 25b, a large arc may be generated and contacts of the relays 25a, 25b may deteriorate. However, since the current generation processing causes the charge current I3 flowing through the relays 25a, 25b to decrease, the deterioration of the contact of each of the relays 25a, 25b due to the disconnection is reduced.

### Relay Disconnection Processing based on Abnormality

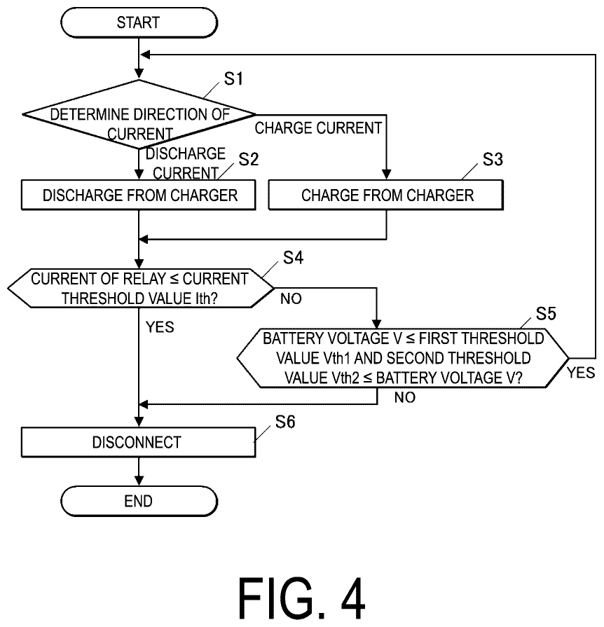

Next, an example of the relay disconnection processing will be described. FIG. 4 is a flowchart illustrating an example of the relay disconnection processing based on the abnormality, performed by the vehicle controller.

The relay disconnection processing in FIG. 4 is started by the controller 28 when a current abnormality of the battery 12 is detected and a request for stopping the current of the electric device 11 is issued but the abnormality is not eliminated (for example, the current does not decrease to a predetermined value within a predetermined time period). Examples of the above-described current abnormality include the occurrence of a current that deviates from a current assumed for control, the occurrence of a current exceeding an allowable current configured based on the SOC of the battery 12 (for example, a discharge current generated at a lower limit of the SOC, a charge current generated at an upper limit of the SOC, or the like), and the occurrence of a current exceeding an allowable current configured based on operational parameters (chargeable/dischargeable power, temperature, or the like) of the battery 12. The current abnormality includes a first abnormality in which the discharge current continues to flow to the battery 12, and a second abnormality in which the charge current continues to flow to the battery 12.

When the relay disconnection processing is started, first, the controller 28 determines the direction of the current flowing through the relays 25a, 25b (step S1). For example, the direction of the current flowing through the relays 25a, 25b is determined based on a current value of the battery 12 detected by the current sensor 26 or based on the current value and a current value of the charger 22 detected by the current sensor 31. Note that, at step S1, since it is assumed that the current of the charger 22 is sufficiently smaller than the current of the battery 12, the direction of the current flowing through the relays 25a, 25b may be determined only from the current value of the battery 12 detected by the current sensor 26. In other words, at step S1, it is determined whether the current abnormality is the first abnormality in which the discharge current continues to flow, or the second abnormality in which the charge current continues to flow. In more detail, a configuration may be adopted in which a detection value of each of the current sensors 26 and 31 becomes positive when the current flows in a direction from the “+” terminal to the “−” terminal of each of the current sensors 26 and 31 illustrated in the drawings, and the detection value of each of the current sensors 26 and 31 becomes negative when the current flows in the direction opposite to the above-described direction. Since it is assumed here that the current of the charger 22 is sufficiently small, when a value obtained by subtracting the detection value of the current sensor 31 from the detection value of the current sensor 26 is a positive value, the controller 28 determines that the discharge current is flowing through the relays 25a, 25b. Conversely, when the value obtained by subtracting the detection value of the current sensor 31 from the detection value of the current sensor 26 is a negative value, the controller 28 determines that the charge current is flowing through the relays 25a, 25b. Note that when a position at which the current sensors 26 and 31 are coupled or a direction in which the current sensors 26 and 31 are coupled are different from those illustrated in the drawings, the controller 28 can perform the same determination by the same calculation by inverting the positive and the negative of the detection values of the current as necessary.

As a result, when it is determined that the discharge current is flowing, the controller 28 sends a request to the charge controller 29 to cause the charger 22 to perform the discharge operation (step S2). On the other hand, when it is determined that the charge current is flowing, the controller 28 sends a request to the charge controller 29 to cause the charger 22 to perform the charge operation (step S3). Step S2 or S3 is the current generation processing illustrated in FIG. 2C or FIG. 3C, and step S2 or S3 causes the current flowing through the relay 25a, 25b to decrease.

Next, the controller 28 determines whether the current of the relays 25a, 25b is equal to or less than a current threshold value Ith (step S4). The current value of the relays 25a, 25b can be calculated as a difference between the current value detected by the current sensor 26 (in other words, the current value of the battery 12) and the current value detected by the current sensor 31 (in other words, the current value of the charger 22). For example, if the “+” terminals and the “−” terminals of the current sensors 26 and 31 are coupled in the above-described direction, the controller 28 can subtract the detection value of the current sensor 26 from the detection value of the current sensor 31 and can calculate the absolute value of the value obtained by the subtraction as the current value of the relays 25a, 25b. When the coupled position or the coupling direction of the current sensors 26 and 31 are different from those illustrated in the drawings, the controller 28 can calculate the same current value by the same calculation by inverting the positive and the negative of the detection values of the current as necessary. Alternatively, the controller 28 may subtract the absolute value of the detection value of the current sensor 26 from the absolute value of the detection value of the current sensor 31 and may calculate the absolute value of the value obtained by the subtraction as the current value of the relays 25a, 25b. The current threshold value Ith is configured to a value that can reduce the magnitude of the arc generated at the relays 25a, 25b.

If the result of the determination at step S4 is YES, the controller 28 disconnects the relays 25a, 25b (step S6). Then, the relay disconnection processing is ended. By disconnecting the relays 25a, 25b after reducing the current in this manner, the deterioration of each of the relays 25a, 25b can be sufficiently reduced.

On the other hand, if the result of the determination at step S4 is NO, the controller 28 determines whether the voltage of the battery 12 is equal to or less than a first threshold value Vth1 and equal to or greater than a second threshold value Vth2 (step S5). As the first threshold value Vth1, for example, an upper limit value of an allowable voltage range (“rated voltage margin value” or the like) is configured. The second threshold value Vth2 is smaller than the first threshold value Vth1. As the second threshold value Vth2, a lower limit value of the allowable voltage range (for example, “discharge cut-off voltage +margin value” or the like) is configured. The voltage value of the battery 12 is obtained from the output of the voltage sensor 27.

If the result of the determination at step S5 is YES, the controller 28 returns the processing to step S1, repeats the current generation processing at step S2 or S3, and performs the determination processing at step S4 once again. By repeatedly continuing the current generation processing, there is a high possibility that the current of the relays 25a, 25b can be reduced to the current threshold value Ith or less.

On the other hand, if the result of the determination at step S5 is NO, the controller 28 does not repeat the current generation processing, that is, stops the current generation processing, and disconnects the relays 25a, 25b (step S6). Then, the relay disconnection processing is ended. Since the current generation processing at step S2 or S3 causes the battery 12 to instantaneously discharge or charge to near the limit of the discharge capacity or the charge capacity, respectively, of the battery 12, it is desirable to avoid the current generation processing excessively performed. Thus, by performing the determination and branching processing at step S5, it is possible to inhibit the current generation processing from being excessively performed, and thus the battery 12 can be protected.

Note that even when the determination result at step S5 is NO and the relays 25a, 25b are disconnected, since the current generation processing is performed at step S2 or S3 preceding step S5, the current flowing through the relays 25a, 25b has been already reduced. Thus, even in the above-described case, the deterioration of each of the relays 25a, 25b is reduced.

A program of the above-described relay disconnection processing is stored in a non transitory computer readable medium 28a included in the controller 28. The controller 28 may be configured to read a program stored on a portable non transitory computer readable medium and execute the program. The portable non transitory computer readable medium may store the above-described program of the relay disconnection processing.

As described above, according to the power transmission system 20 of the present embodiment, when the request for disconnecting the relays 25a, 25b is issued based on the abnormality, the controller 28 disconnects the relays 25a, 25b after performing the current generation processing. The current generation processing is processing of causing the current to flow between the charger 22 and the battery 12 in the direction in which the current of the relay 25a, 25b decreases. By the current generation processing, the current of the relays 25a, 25b can be quickly reduced, and the relays 25a, 25b can be disconnected in a state where the currents of the controller 28 and the relays 25a, 25b have been reduced. Therefore, it is possible to respond to the request for quickly disconnecting the relays 25a, 25b while reducing the deterioration of each of the relays 25a, 25b.

In the current generation processing, in response to the generation of the current, power is transmitted between the battery 12 and the charger 22. Therefore, in order to perform the current generation processing, a supply source or a supply destination of the power is to be used. According to the power transmission system 20 of the present embodiment, in the current generation processing, power is transmitted between the battery 12 and the charging facility 41 via the power intake unit 21. With such a configuration, the electrically powered vehicle 1 does not need to be provided with a configuration for storing power for generating the charge current in the power generation processing, nor a configuration for consuming or absorbing the discharge current in the power generation processing. Therefore, the power transmission system 20 can be made compact.

Further, according to the power transmission system 20 of the present embodiment, when the first abnormality occurs in which the discharge current continues to flow from the battery 12 to the electric device 11, the current generation processing is processing of causing a current (in other words, the discharge current) to flow in a direction in which power is transmitted from the battery 12 to the charger 22. When the second abnormality occurs in which the charge current continues to flow from the electric device 11 to the battery 12, the current generation processing is processing of causing a current (in other words, the charge current) to flow in a direction in which a current is transmitted from the charger 22 to the battery 12. By such current generation processing, as illustrated in FIGS. 2C and 3C, the current of the relays 25a, 25b can be quickly reduced.

Further, according to the power transmission system 20 of the present embodiment, the controller 28 stops the current generation processing when the voltage of the battery 12 exceeds the first threshold value Vth1 during the current generation processing (see steps S5 and S6 in FIG. 4). Therefore, it is possible to inhibit the current generation processing from causing the voltage of the battery 12 to excessively increase, and thus the battery 12 can be protected.

Further, according to the power transmission system 20 of the present embodiment, the controller 28 stops the current generation processing when the voltage of the battery 12 becomes lower than the second threshold value Vth2 during the current generation processing (see steps S5 and S6 in FIG. 4). Therefore, it is possible to inhibit the current generation processing from causing the voltage of the battery 12 to excessively decrease, and thus the battery 12 can be protected.

Further, according to the power transmission system 20 of the present embodiment, the power intake unit 21 is configured to be able to transmit power from the charging facility 41 provided in the traveling lane during traveling in the non-contact manner. Therefore, even when the request for disconnecting the relays 25a, 25b is issued based on an abnormality that has occurred during traveling, the request can be responded to.

An embodiment of the present invention has been described above. However, the present invention is not limited to the embodiment described above. For example, in the above-described embodiment, an example is described in which the controller 28 that controls the relays 25a, 25b is the vehicle controller that performs the travel control of the electrically powered vehicle 1. In addition, an example is described in which the charge controller 29 that controls the charger 22 is provided separately from the controller 28. However, the controller that controls the relays 25a, 25b, the controller that controls traveling of the electrically powered vehicle 1, and the controller that controls the charger 22 may be integrated into one controller. Alternatively, the controllers may be provided as independent controllers, or any two of the controllers may be integrated and the other controller may be provided independently. In this case, by the multiple controllers operating in cooperation with each other through communication, processing similar to that of the above-described embodiment can be implemented.

Further, in the above-described embodiment, an example is described in which the controller 28 disconnects the relays 25a, 25b after performing the current generation processing based on the request for disconnecting the relays 25a, 25b based on the abnormality, both during discharging and charging of the battery 12. However, the controller 28 may perform the current generation processing during discharging of the battery 12 or may perform the current generation processing during charging of the battery 12. Even with such a configuration, it is possible to respond to the request for quickly disconnecting the relays 25a, 25b while suppressing the progress of deterioration of each of the relays 25a, 25b during one of the charging or the discharging.

Further, in the above-described embodiment, the controller 28 performs the processing of stopping the current generation processing both when the voltage of the battery 12 exceeds the first threshold value Vth1 and when the voltage of the battery 12 becomes lower than the second threshold value Vth2 during the current generation processing. However, the controller 28 may perform the processing of stopping the current generation processing in one of those cases. In addition, in the above-described embodiment, a configuration example is described in which the power intake unit 21 can transmit the power to and from the charging facility 41 during traveling in the non-contact manner. However, the power intake unit 21 may be configured to be able to transmit the power to and from the charging facility in the non-contact manner or via a cable or the like, when the vehicle is stopped. When such a configuration is adopted, when the request for disconnecting the relays 25a, 25b based on the abnormality is issued when the vehicle is stopped, the current generation processing can be realized by exchanging the power with the charging facility.

Although, in the above-described embodiment, an example is described in which the electrically powered vehicle 1 is an Electric Vehicle (EV), the power transmission system 20 according to the present embodiment may be mounted on an electrically powered vehicle such as a Hybrid Electric Vehicle (HEV) or a Plug-in Hybrid Electric Vehicle (PHEV). In addition, details described in the embodiment can be appropriately changed without departing from the gist of the invention.

### INDUSTRIAL APPLICABILITY

The present invention can be used for a power transmission system of an electrically powered vehicle.

### REFERENCE SIGNS LIST

1 Electrically powered vehicle
2 Driving wheel
11 Electric device
11a Electric motor
11b Inverter
12 Battery
20 Power transmission system
21 Power intake unit
22 Charger
23 First power line
24 Second power line
25a, 25b Relay
26 Current sensor
27 Voltage sensor
28 Controller
29 Charge controller
31 Current sensor
41 Charging facility
I1, I2 Discharge current
I3, I4 Charge current

1. A power transmission system for an electrically powered vehicle, the power transmission system being configured to be mounted on the electrically powered vehicle, the electrically powered vehicle comprising a battery configured to store power for traveling and an electric device configured to receive the power from the battery, the power transmission system for the electrically powered vehicle comprising:
a power intake unit configured to take in power from a charging facility provided outside the electrically powered vehicle;
a charger configured to charge the battery using the power taken in via the power intake unit;
a first power line configured to transmit the power between the electric device and the battery;
a second power line configured to transmit the power between the battery and the charger;
a relay configured to cut off the first power line without cutting off the second power line; and
a controller configured to control the relay,
wherein the controller is configured to disconnect the relay after performing current generation processing when a request for disconnecting the relay is issued based on an abnormality, and
wherein the current generation processing causes a current to flow between the charger and the battery, the current flowing in a direction where a current of the relay decreases.

2. The power transmission system for the electrically powered vehicle according to claim 1,
wherein the current generation processing further transmits the power between the battery and the charging facility via the power intake unit.

3. The power transmission system for the electrically powered vehicle according to claim 1,
wherein the abnormality includes a first abnormality where a discharge current continues to flow from the battery to the electric device and a second abnormality where a charge current continues to flow from the electric device to the battery,
wherein the current generation processing causes the current to flow in a direction of transmitting the power from the battery to the charger when the first abnormality occurs, and
causes the current to flow in a direction of transmitting the power from the charger to the battery when the second abnormality occurs.

4. The power transmission system for the electrically powered vehicle according to claim 1,
wherein the controller is configured to stop the current generation processing when a voltage of the battery exceeds a first threshold value during the current generation processing.

5. The power transmission system for the electrically powered vehicle according to claim 1,
wherein the controller is configured to stop the current generation processing when a voltage of the battery becomes lower than a second threshold value during the current generation processing.

6. The power transmission system for the electrically powered vehicle according to claim 1,
wherein the power intake unit is configured to transmit the power in a non-contact manner to and from the charging facility provided in a traveling lane.
